(19) United States
(12) Patent Application Publication
(10) Pub. No.: US 2024/0096000 A1
(43) Pub. Date: Mar. 21, 2024

(54) METHOD, DEVICE, AND COMPUTER PROGRAM PRODUCT FOR RENDERING IMAGE

(71) Applicant: Dell Products L.P., Round Rock, TX (US)

(72) Inventors: Zhisong Liu, Shenzhen (CN); Zijia Wang, WeiFang (CN); Zhen Jia, Shanghai (CN)

(21) Appl. No.: 17/965,858

(22) Filed: Oct. 14, 2022

(30) Foreign Application Priority Data
Sep. 16, 2022 (CN) 202211134110.8

(51) Int. Cl. G06T 15/20; G06T 3/40; G06T 7/62; G06T 7/90; G06T 11/00

(52) U.S. Cl. CPC G06T 15/20; G06T 3/4046; G06T 7/62; G06T 7/90; G06T 11/001; G06T 2207/10024; G06T 2207/20021; G06T 2207/20084; G06T 2210/52

(57) ABSTRACT

Embodiments of the present disclosure relate to a method, a device, and a computer program product for rendering an image. The method includes determining, based on a coordinate value of a target point in a target scenario and a viewing direction for the target point, a rendering parameter for the target point. The method further includes adjusting the rendering parameter based on the viewing direction and by performing an upsampling operation on the rendering parameter. The method further includes rendering an image for the target scenario based on the adjusted rendering parameter. By means of the method, resources required by processing of image data are reduced; the image data processing speed is increased; and fast rendering of a high-resolution image can be achieved.

### RELATED APPLICATION

The present application claims priority to Chinese Patent Application No. 202211134110.8, filed Sep. 16, 2022, and entitled “Method, Device, and Computer Program Product for Rendering Image,” which is incorporated by reference herein in its entirety.

### FIELD

Embodiments of the present disclosure generally relate to the field of image processing, and specifically, to a method, a device, and a computer program product for rendering an image.

### BACKGROUND

With the development of computer technology, there are more and more applications involving image processing, which greatly increases the demand for image processing. For example, applications involving virtual worlds have guided people to a new era of image display and interaction. However, in processing images, for example, in a virtual world, the amount of processed image data is extremely large, so that images of various scenarios need to be rendered in this process. However, there are still many problems to be solved in this process.

### SUMMARY

Embodiments of the present disclosure provide a method, a device, and a computer program product for rendering an image.

According to a first aspect of the present disclosure, a method for rendering an image is provided. The method includes determining, based on a coordinate value of a target point in a target scenario and a viewing direction for the target point, a rendering parameter for the target point. The method further includes adjusting the rendering parameter based on the viewing direction and by upsampling the rendering parameter. The method further includes rendering an image for the target scenario based on the adjusted rendering parameter.

According to a second aspect of the present disclosure, an electronic device is provided. The electronic device includes at least one processor; and a memory coupled to the at least one processor and having instructions stored thereon, wherein the instructions, when executed by the at least one processor, cause the electronic device to execute actions including: determining, based on a coordinate value of a target point in a target scenario and a viewing direction for the target point, a rendering parameter for the target point; adjusting the rendering parameter based on the viewing direction and by upsampling the rendering parameter; and rendering an image for the target scenario based on the adjusted rendering parameter.

According to a third aspect of the present disclosure, a computer program product is provided, which is tangibly stored on a non-transitory computer-readable medium and includes machine-executable instructions, wherein the machine-executable instructions, when executed by a machine, cause the machine to perform steps of the method in the first aspect of the present disclosure.

### BRIEF DESCRIPTION OF THE DRAWINGS

By more detailed description of example embodiments of the present disclosure, provided herein with reference to the accompanying drawings, the above and other objectives, features, and advantages of the present disclosure will become more apparent, where identical reference numerals generally represent identical components in the example embodiments of the present disclosure.

FIG. 1 illustrates a schematic diagram of an example environment in which a device and/or a method according to embodiments of the present disclosure can be implemented;

FIG. 2 illustrates a schematic diagram of a framework for adjusting a rendering parameter according to an embodiment of the present disclosure;

FIG. 3 illustrates a flow chart of a method for rendering an image according to an embodiment of the present disclosure;

FIG. 4 illustrates a schematic diagram of division of a three-dimensional volume of a target scenario according to an embodiment of the present disclosure;

FIG. 5 illustrates a flow chart of a method for adjusting a rendering parameter according to an embodiment of the present disclosure;

FIG. 6 illustrates a schematic diagram of a model used for adjusting a rendering parameter according to an embodiment of the present disclosure; and

FIG. 7 illustrates a schematic block diagram of an example device suitable for implementing embodiments of the present disclosure.

In the drawings, identical or corresponding numerals represent identical or corresponding parts.

### DETAILED DESCRIPTION

Illustrative embodiments of the present disclosure will be described in more detail below with reference to the accompanying drawings. Although the accompanying drawings show some embodiments of the present disclosure, it should be understood that the present disclosure can be implemented in various forms, and should not be explained as being limited to the embodiments disclosed herein. Rather, these embodiments are provided for understanding the present disclosure more thoroughly and completely. It should be understood that the accompanying drawings and embodiments of the present disclosure are for illustrative purposes only, and are not intended to limit the protection scope of the present disclosure.

In the description of embodiments of the present disclosure, the term “include” and similar terms thereof should be understood as open-ended inclusion, i.e., “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below.

As stated above, there are still many problems to be solved in the process of rendering images in various scenarios. In order to solve the above-mentioned problems, a deep learning technology is introduced into image processing to render an image. A neural radiant field (NeRF) is one of the most popular methods in image rendering. The method uses a deep neural network to implicitly learn the three-dimensional (3D) representation from a group of two-dimensional (2D) images for one scenario. The NeRF is obtained by joint training with rough rendering and fine rendering. However, in the process of image rendering using the NeRF, a large amount of computation is required. For example, an image with a target resolution of 800×800 is given, and 192 points need to be sampled along each ray. In such an arrangement, 122.88 million 3D points need to be searched in the neural network, which means that it also takes a few seconds to render an image via the NeRF on a high-end graphics processing unit (GPU), leading to a long image rendering time. In addition, this method cannot obtain high-resolution images.

To solve at least the above and other potential problems, an embodiment of the present disclosure provides a method for rendering an image. In this method, a computing device determines, based on a coordinate value of a target point in a target scenario and a viewing direction for the target point, a rendering parameter for the target point. The computing device then further adjusts the rendering parameter, and renders an image for the target scenario using the adjusted rendering parameter. By means of the method, resources required by processing of image data are reduced; the image data processing speed is increased; and fast rendering of a high-resolution image can be achieved.

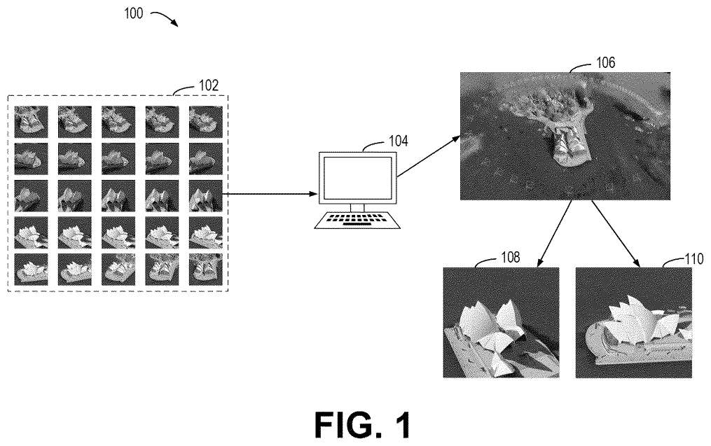

Embodiments of the present disclosure will be further described in detail with reference to the accompanying drawings below. FIG. 1 shows an example environment in which a device and/or a method according to embodiments of the present disclosure can be implemented.

As shown in FIG. 1, example environment 100 can include a group of images 102 acquired for a target scenario. The group of images 102 comprises images of the target scenario taken from different angles. For example, the group of images 102 may be obtained by shooting the target scenario with a camera.

Computing device 104 is configured to receive the group of images 102. Computing device 104 then processes this group of images to generate a point cloud for the target scenario or model 106 for describing a 3D target scenario. A 2D image 108 or 110 of the scenario is obtained when a user inputs a position and a target viewing angle for watching the target scenario for the point cloud or model.

In some embodiments, a dedicated image data processor is provided in computing device 104 to process the group of images 102 to generate a point cloud for the target scenario or model 106 for describing a 3D target scenario. In some embodiments, a processor of computing device 104 directly processes the group of images 102 to generate a point cloud for the target scenario or model 106 for describing a 3D target scenario. Alternatively, the processor that processes the group of images 102 is arranged on a device connected to computing device 104. The above examples are intended to describe illustrative embodiments of the present disclosure only and are not specific limitations to the present disclosure.

Example computing device 104 includes, but is not limited to, a personal computer, a server computer, a handheld or laptop device, a mobile device (such as a mobile phone, a personal digital assistant (PDA), and a media player), a multi-processor system, a consumer electronic product, a minicomputer, a mainframe computer, a distributed computing environment including any of the above systems or devices, etc.

It should be understood that an architecture and functions of example environment 100 are described for illustrative purposes only, without implying any limitation to the scope of the present disclosure. Embodiments of the present disclosure may also be applied to other environments having different structures and/or functions.

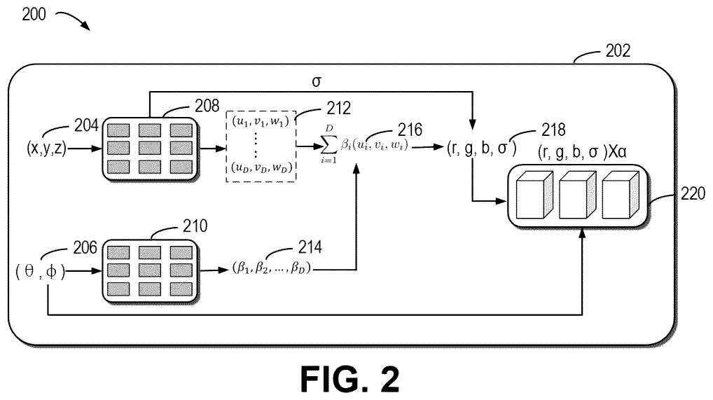

An example environment in which a device and/or a method according to embodiments of the present disclosure can be implemented has been described above in FIG. 1. The framework for adjusting a rendering parameter is further described below in combination with FIG. 2. FIG. 2 illustrates a schematic diagram 200 of a framework 202 for adjusting a rendering parameter according to an embodiment of the present disclosure.

In FIG. 2, in framework 202 for adjusting a rendering parameter, for a position coordinate of one point in a 3D image of the target scenario, such as coordinate 204 (x, y, z), the coordinate of the point is a coordinate in a coordinate system taking a target object in the target scenario as an origin. For example, in a process of calculating a group of pictures for a certain scenario, a target object in the group of images is determined, and then a center point of the target object is used as an origin of coordinates. This is only an example, rather than a specific limitation to the present disclosure. The coordinate system may also be a coordinate system taking a viewpoint position as the origin. Coordinate 204 (x, y, z) of the point is input into coordinate position mapping model 208, so that multidimensional data representation 212 (u₁, v₁, w₁) . . . (u_{D}, v_{D}, w_{D}) of a color parameter corresponding to the coordinate point can be obtained. The representation is a D-dimensional vector of a depth radiation pattern that forms view coherent radiation at the coordinate point, where D is the number of data representations, and u, v, w are respectively component representations of corresponding color parameters r, g, b. A volume density a of the coordinate point can also be obtained using coordinate position mapping model 208. The volume density a is used for indicating a transparency of the target point, that is, a degree or probability of a light ray passing through the point.

Viewing direction 206 through this point includes two parameters θ and φ, where θ represents a rotation angle with respect to an x-axis in a 3D coordinate system, and φ represents a rotation angle with respect to a y-axis in the 3D coordinate system. Viewing direction 206 is input into viewing direction mapping model 210 to obtain weight set 214 for the multidimensional data representation of the point. Each weight value in weight set 214 is then multiplied by each component representation in the corresponding multidimensional data representation to obtain calculation results represented by the formula 216, that is, the color parameter (r, g, b) for the point is obtained. The color parameter and the volume density are then combined to form rendering parameter 218. Rendering parameter 218 and viewing direction 206 are then input into super-resolution model 220 to adjust the rendering parameter to generate a resolution-increased rendering parameter. Therefore, a user can obtain a super-resolution rendered image while acquiring the image for the target scenario.

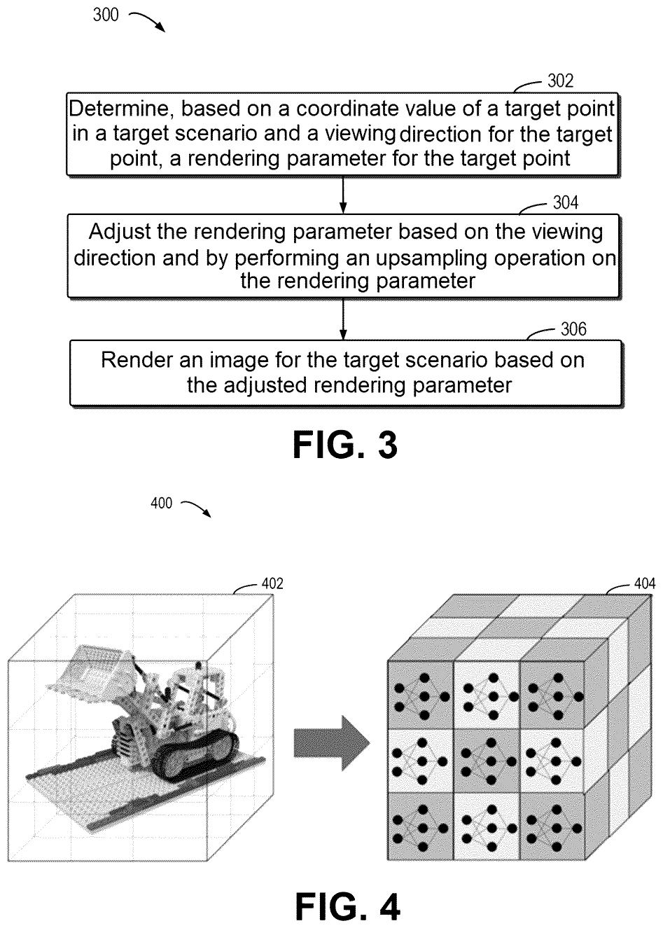

With reference to FIG. 1 and FIG. 2 above, the example environment in which the device and/or method according to embodiments of the present disclosure can be implemented and the framework used for adjusting a rendering parameter are described. A flow chart of a method 300 for rendering an image according to an embodiment of the present disclosure is described below with reference to FIG. 3. The method 300 in FIG. 3 may be implemented by computing device 104 in FIG. 1 or any suitable computing device.

At block 302, based on a coordinate value of a target point in a target scenario and a viewing direction for the target point, a rendering parameter for the target point is determined. For example, after obtaining the point cloud for the target scenario or model 106 formed by the group of images 102 and used for describing the 3D target scenario, the computing device of FIG. 1 may acquire a rendering parameter with one viewing direction at one target point in the target scenario. As shown in FIG. 2, according to coordinate 204 (x, y, z) and viewing direction 206 (θ, φ) for the target point, rendering parameter 218 (r, g, b, σ) for the target point is obtained. The rendering parameter includes a color parameter (r, g, b) and a volume density σ.

In some embodiments, the computing device determines a multidimensional data representation of the color parameter for the target point based on the coordinate value of the target point. As shown in FIG. 2, computing device 104 obtains multidimensional data representation 212 through a coordinate mapping model. The computing device then determines a weight set related to the multidimensional data representation based on the viewing direction. As shown in FIG. 2, the viewing direction is input into viewing direction mapping model 210 to obtain weight set 214. The computing device then determines the color parameter for the target point based on the multidimensional data representation and the weight set. For example, the color parameter is calculated by formula 216 in FIG. 2. In this way, the color parameter for the target point can be quickly determined, and the data processing efficiency is improved. The process of calculating the color parameter is shown by Equation (1) below:

Fₚₒₛ(Θ):p→σ,(u,v,w)

F_{dir}(Φ):d→β

c=(r,g,b)=Σᵢ₌₁^{D}βᵢ(uᵢ,vᵢ,wᵢ)=β^{T}·(u,v,w) (1)
where Fₚₒₛ represents a position mapping model; pos represents a position; p represents a coordinate position; σ represents a volume density; (u, v, w) is a D-dimensional vector of a depth radiation pattern that forms view coherent radiation at position p, that is, a component representation corresponding to the color parameter (r, g, b); Θ is a network parameter of Fₚₒₛ; and F_{dir} represents a viewing direction mapping model, where Φ is the network parameter, d is the viewing direction, and β is a D-dimensional weight vector of D components of the depth radiation pattern. An inner product of a weight and the D-dimensional vector of the depth radiation pattern forms an estimated color c=(r, g, b) at position p observed from direction d, r for red, g for green, and b for blue.

In some embodiments, when determining the rendering parameter for the target point, computing device 104 determines the volume density for the target point based on the coordinate value of the target point. As shown in FIG. 2, coordinate position mapping model 208 may also determine the volume density based on the coordinate value. The volume density and the color parameter are then combined to form rendering parameter 218. In this way, the rendering parameter can be quickly calculated, and the image rendering efficiency is improved.

In some embodiments, a fully connected neural network model is used to determine the rendering parameter during the determination of the rendering parameter for the target point. For example, the fully connected neural network model used is trained based on a plurality of images of the target scenario taken from different poses, and poses and internal parameters of the cameras corresponding to the plurality of images respectively. Specifically, to generate fine-grained rendering data, a loss function represented by Equation (2) below can be used to train the fully connected neural network model:

[symbol]

= [symbol] [∥Ĉ_{c}(r)−C(r)∥₂²+∥Ĉ_{f}(r)−C(r)∥₂²]

Ĉ_{c}(r)=Σᵢ₌₁^{N}^{_{c}}ωᵢcᵢ, where ωᵢ=Tᵢ(1−exp(−σᵢδᵢ))

Ĉ_{f}(r)=Σᵢ₌₁^{N}Tᵢ(1−exp(−σᵢδᵢ))cᵢ, where Tᵢ=exp(−Σⱼ₋₁ⁱ⁻¹σᵢδᵢ) (2)
where [symbol] represents a loss function; Ĉ_{c}(r) represents a coarse-grained estimated color; C(r) represents a label color; r represents virtual light; [symbol] represents a light set space; Ĉ_{f}(r) represents a fine-grained estimated color; ∥ . . . ∥₂² represents an operation for calculating an absolute value of an error; i represents a step length of differentiation; N_{c} represents the number of differentiation units from a virtual camera to a target point; cᵢ represents a color at i; ωᵢ represents a differentiation probability at i; σᵢ represents a volume density at i; δᵢ represents a distance between adjacent points in a three-dimensional space; N represents the total number of points; and Tᵢ represents a time function.

In some embodiments, coordinate position mapping model 208 and viewing direction mapping model 210 for determining the rendering parameter for the target point are implemented by a fully connected neural network model. Inputs and outputs of the two models are independent of each other, and the calculation processes of the two models are independent of each other and can be concurrently carried out. The outputs of coordinate position mapping model 208 and viewing direction mapping model 210 are combined to form the color parameter. In another example, coordinate position mapping model 208 and viewing direction mapping model 210 are implemented by a mapping relationship table. The above examples are intended to describe illustrative embodiments of the present disclosure only and are not specific limitations to the present disclosure.

In some embodiments, the 3D volume where the target scenario is located is too large, and it is relatively slow to process the 3D coordinate points in the target scenario in sequence by the models. In order to speed up the data processing, the 3D volume where the target scenario is located may be segmented, and the 3D volume is segmented into a plurality of sub-volumes. Each sub-volume is then processed using coordinate position mapping model 208 and viewing direction mapping model 210. Alternatively or additionally, the points in the plurality of sub-volumes are concurrently processed using a plurality of fully connected neural network models, thus improving the data processing efficiency. FIG. 4 illustrates an example of division of a three-dimensional volume of a target scenario according to an embodiment of the present disclosure.

In FIG. 4, example 400 includes volume 402 including an excavator and determined from a group of images of the excavator. Volume 402 of the excavator is then divided into a plurality of sub-volumes to form volume 404 including the plurality of sub-volumes. Each sub-volume in volume 404 may be processed respectively using coordinate position mapping model 208 and viewing direction mapping model 210, thereby speeding up the data processing of image points in volume 402.

Returning now to FIG. 3 to continue the description, at block 304, the rendering parameter is adjusted based on the viewing direction and by performing an upsampling operation on the rendering parameter. For example, computing device 104 inputs the viewing direction and the rendering parameter into super-resolution model 220 to adjust the rendering parameter, thereby increasing the resolution of the image.

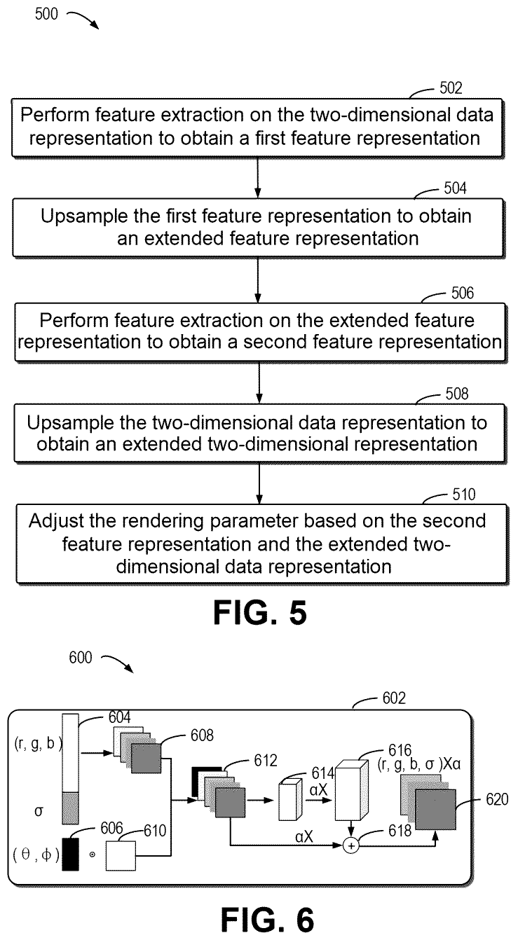

In some embodiments, the computing device may rearrange rendering parameter and viewing direction data. With respect to the rendering parameter and the viewing direction, the computing device generates a two-dimensional data representation for the rendering parameter and the viewing direction in different ways. In one example, the computing device rearranges the value of each parameter in the rendering parameter to generate a corresponding two-dimensional data representation. The computing device determines a two-dimensional data representation for the viewing direction based on the viewing direction and a predetermined matrix. In this way, the data arrangement of the rendering parameter and the viewing direction can be quickly adjusted, thereby speeding up the data processing and improving the data processing efficiency. After obtaining the two-dimensional data representation, the computing device adjusts the rendering parameter by performing an upsampling operation on the two-dimensional data representation. This process is described below with reference to FIG. 5 and FIG. 6. In this way, the resolution of the image is increased, and the user experience is improved.

At block 306, an image for the target scenario is rendered based on the adjusted rendering parameter. After obtaining the adjusted rendering parameter, a target rendering parameter associated with the target point in the target scenario can be obtained. The image of the target scenario related to the viewing direction can be obtained by acquiring rendering parameters of other points related to the viewing direction. In some embodiments, the computing device renders the image for the target scenario based on the viewing direction and the adjusted rendering parameter. A high-resolution image can be obtained by adjusting the rendering parameter.

By means of the method, resources required by processing of image data are reduced; the image data processing speed is increased; and fast rendering of a high-resolution image can be achieved.

The flow chart of the method for rendering an image according to an embodiment of the present disclosure is described above with reference to FIG. 3 and FIG. 4. The process of adjusting the rendering parameter is described below with reference to FIG. 5 and FIG. 6. FIG. 5 illustrates a flow chart of a method 500 for adjusting the rendering parameter according to an embodiment of the present disclosure, and FIG. 6 illustrates a schematic diagram 600 of a model 602 used for adjusting a rendering parameter according to an embodiment of the present disclosure. The method 500 of FIG. 5 may be implemented on computing device 104 in FIG. 1 or any suitable computing device.

In FIG. 5, at block 502, feature extraction is performed on two-dimensional data representation to obtain a first feature representation. For example, computing device 104 performs feature extraction on two-dimensional data using a convolutional neural network. As shown in FIG. 6, computing device 104 first rearranges one-dimensional data 604 formed by the color parameters and volume densities of various data points to form two-dimensional data representation 608 for different parameters. For example, the color parameter c=(r, g, b) and the volume density a are first reshaped into a two-dimensional mapping X=(R, G, B, Z)∈ [symbol] , where M and N are the length and width of the two-dimensional data representation, and R, G, B, Σ respectively represent a two-dimensional arrangement of the color parameter r, g, b, as well as the volume density σ. Viewing direction data (θ, φ) 606 is multiplied by identity map 610 to obtain a corresponding two-dimensional data representation, and the identity map is, for example, a predetermined matrix where values are all 1, thus obtaining two-dimensional data representation Y∈ [symbol] for the viewing direction. The obtained two-dimensional data representation for the viewing direction is then combined with two-dimensional data representation 608 to form a group of two-dimensional data representations 612. The feature extraction operation, such as a two-dimensional convolution operation, is then performed on two-dimensional data representations 612 to obtain first feature representation 614 for two-dimensional data representations 612.

Returning to FIG. 5 to continue the description, at block 504, the first feature representation is upsampled to obtain an extended feature representation. For example, computing device 104 upsamples the first feature representation to expand features to increase the number of features. In one example, the first feature representation may be interpolated to obtain the extended feature representation during the upsampling of the first feature representation to obtain the extended feature representation. As shown in FIG. 6, a bicubic operation is performed on first feature representation 614 to amplify a parameter feature by a times to obtain extended feature representation 616. The above examples are only used to describe illustrative embodiments of the present disclosure, but not to limit the present disclosure. Those skilled in the art can use any suitable upsampling operation to extend or increase the feature representation.

At block 506, feature extraction is performed on the extended feature representation to obtain a second feature representation. Computing device 104 may also perform the two-dimensional convolution operation again on the extended feature representation to obtain the second feature representation.

At block 508, the two-dimensional data representation is upsampled to obtain an extended two-dimensional data representation. In order to ensure the accuracy of the data, the computing device may also perform the upsampling operation on the two-dimensional data representation. As shown in FIG. 6, the bicubic operation is performed on the two-dimensional data representation to amplify the two-dimensional data representation by a times to obtain the extended two-dimensional data representation.

At block 510, the rendering parameter is adjusted based on the second feature representation and the extended two-dimensional data representation. The computing device then combines the second feature representation and the extended two-dimensional data representation to form the adjusted rendering parameter. As shown in FIG. 6, a convolution operation is performed on extended feature representation 616. After the operation is completed, the extended feature representation is combined with extended two-dimensional data representation 618 to form adjusted rendering parameter 620. In this way, rapid extension of the rendering parameter can be achieved; the efficiency of acquiring a high-resolution image is improved; and the user experience is enhanced.

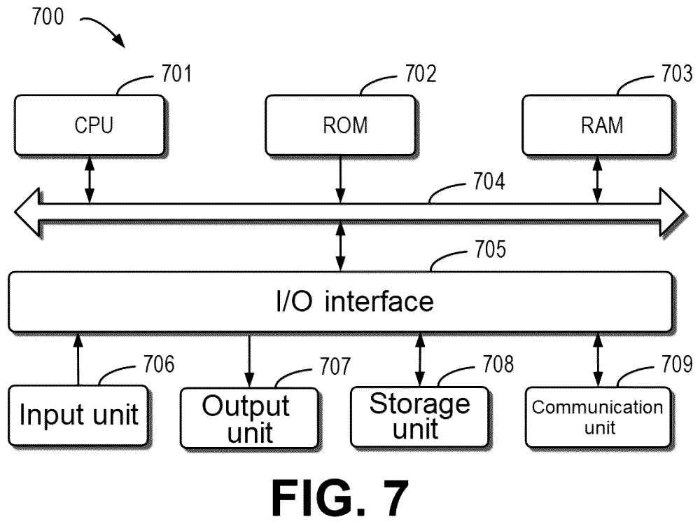

FIG. 7 shows a schematic block diagram of example device 700 that can be used to implement embodiments of the present disclosure. Computing device 104 in FIG. 1 may be implemented by device 700. As shown in the figure, device 700 includes central processing unit (CPU) 701 that may perform various appropriate actions and processing according to computer program instructions stored in read-only memory (ROM) 702 or computer program instructions loaded from storage unit 708 to random access memory (RAM) 703. Various programs and data required for the operation of device 700 may also be stored in RAM 703. CPU 701, ROM 702, and RAM 703 are connected to each other through bus 704. Input/Output (I/O) interface 705 is also connected to bus 704.

A plurality of components in device 700 are connected to I/O interface 705, including: input unit 706, such as a keyboard and a mouse; output unit 707, such as various types of displays and speakers; storage unit 708, such as a magnetic disk and an optical disc; and communication unit 709, such as a network card, a modem, and a wireless communication transceiver. Communication unit 709 allows device 700 to exchange information/data with other devices via a computer network, such as the Internet, and/or various telecommunication networks.

Various processes and processing described above, e.g., methods 300 and 500, may be executed by CPU 701. For example, in some embodiments, methods 300 and 500 may be embodied as a computer software program that is tangibly included in a machine-readable medium, such as storage unit 708. In some embodiments, part or all of the computer program may be loaded and/or installed onto device 700 via ROM 702 and/or communication unit 709. When the computer program is loaded into RAM 703 and executed by CPU 701, one or more actions of methods 300 and 500 described above can be implemented.

Illustrative embodiments of the present disclosure include a method, an apparatus, a system, and/or a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a RAM, a ROM, an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for executing the operation of the present disclosure may be assembly instructions, instruction set architecture (ISA) instructions, machine instructions, machine-dependent instructions, microcode, firmware instructions, status setting data, or source code or object code written in any combination of one or a plurality of programming languages, the programming languages including object-oriented programming languages such as Smalltalk and C++, and conventional procedural programming languages such as the C language or similar programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, including a local area network (LAN) or a wide area network (WAN), or may be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

Various aspects of the present disclosure are described herein with reference to flow charts and/or block diagrams of the method, the apparatus (system), and the computer program product according to embodiments of the present disclosure. It should be understood that each block of the flow charts and/or the block diagrams and combinations of blocks in the flow charts and/or the block diagrams may be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or a plurality of blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or a plurality of blocks in the flow charts and/or block diagrams.

The computer-readable program instructions may also be loaded to a computer, a further programmable data processing apparatus, or a further device, so that a series of operating steps may be performed on the computer, the further programmable data processing apparatus, or the further device to produce a computer-implemented process, such that the instructions executed on the computer, the further programmable data processing apparatus, or the further device may implement the functions/actions specified in one or a plurality of blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or a plurality of executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on involved functions. It should be further noted that each block in the block diagrams and/or flow charts as well as a combination of blocks in the block diagrams and/or flow charts may be implemented by using a special hardware-based system that executes specified functions or actions, or implemented by using a combination of special hardware and computer instructions.

Illustrative embodiments of the present disclosure have been described above. The above description is illustrative, rather than exhaustive, and is not limited to the disclosed various embodiments. Numerous modifications and alterations will be apparent to persons of ordinary skill in the art without departing from the scope and spirit of the illustrated embodiments. The selection of terms as used herein is intended to best explain the principles and practical applications of the various embodiments and their associated technical improvements, so as to enable persons of ordinary skill in the art to understand the embodiments disclosed herein.

What is claimed is:

1. A method, comprising:
determining, based on a coordinate value of a target point in a target scenario and a viewing direction for the target point, a rendering parameter for the target point;
adjusting the rendering parameter based on the viewing direction and by performing an upsampling operation on the rendering parameter; and
rendering an image for the target scenario based on the adjusted rendering parameter.

2. The method according to claim 1, wherein the rendering parameter comprises a color parameter, and the determining a rendering parameter for the target point comprises:
determining a multidimensional data representation of a color parameter for the target point based on the coordinate value of the target point;
determining, based on the viewing direction, a weight set related to the multidimensional data representation; and
determining the color parameter for the target point based on the multidimensional data representation and the weight set.

3. The method according to claim 2, wherein the rendering parameter further comprises a volume density; the volume density is used for indicating a transparency of the target point; and the determining a rendering parameter for the target point further comprises:
determining a volume density for the target point based on the coordinate value of the target point; and
determining the rendering parameter based on the volume density and the color parameter.

4. The method according to claim 1, wherein the determining a rendering parameter for the target point comprises:
determining the rendering parameter using a first fully connected neural network model.

5. The method according to claim 4, further comprising:
determining a volume corresponding to the target scenario; and
dividing the volume into a plurality of sub-volumes, wherein the sub-volumes in the plurality of sub-volumes comprise the target point.

6. The method according to claim 5, further comprising:
performing parallel processing on points in the plurality of sub-volumes using a plurality of fully connected neural network models, the plurality of fully connected neural network models comprising the first fully connected neural network model.

7. The method according to claim 1, wherein the adjusting the rendering parameter comprises:
generating a two-dimensional data representation for the rendering parameter and the viewing direction based on the rendering parameter and the viewing direction; and
adjusting the rendering parameter based on the two-dimensional data representation and by upsampling the two-dimensional data representation.

8. The method according to claim 7, wherein the generating a two-dimensional data representation for the rendering parameter and the viewing direction comprises:
rearranging the value of each parameter in the rendering parameter to generate the corresponding two-dimensional data representation; and
determining the two-dimensional data representation for the viewing direction based on the viewing direction and a predetermined matrix.

9. The method according to claim 7, wherein the adjusting the rendering parameter based on the two-dimensional data representation and by upsampling the two-dimensional data representation comprises:
performing feature extraction on the two-dimensional data representation to obtain a first feature representation;
upsampling the first feature representation to obtain an extended feature representation;
performing feature extraction on the extended feature representation to obtain a second feature representation;
upsampling the two-dimensional data representation to obtain an extended two-dimensional data representation; and
adjusting the rendering parameter based on the second feature representation and the extended two-dimensional data representation.

10. The method according to claim 9, wherein the upsampling the first feature representation to obtain an extended feature representation comprises:
interpolating the first feature representation to obtain the extended feature representation.

11. The method according to claim 1, wherein the rendering an image for the target scenario comprises:
rendering the image for the target scenario based on the viewing direction and the adjusted rendering parameter.

12. An electronic device, comprising:
at least one processor; and
a memory coupled to the at least one processor and having instructions stored thereon, wherein the instructions, when executed by the at least one processor, cause the electronic device to perform actions comprising:
determining, based on a coordinate value of a target point in a target scenario and a viewing direction for the target point, a rendering parameter for the target point;
adjusting the rendering parameter based on the viewing direction and by performing an upsampling operation on the rendering parameter; and
rendering an image for the target scenario based on the adjusted rendering parameter.

13. The electronic device according to claim 12, wherein the rendering parameter comprises a color parameter, and the determining a rendering parameter for the target point comprises:
determining a multidimensional data representation of a color parameter for the target point based on the coordinate value of the target point;
determining, based on the viewing direction, a weight set related to the multidimensional data representation; and
determining the color parameter for the target point based on the multidimensional data representation and the weight set.

14. The electronic device according to claim 13, wherein the rendering parameter further comprises a volume density; the volume density is used for indicating a transparency of the target point; and the determining a rendering parameter for the target point further comprises:
determining a volume density for the target point based on the coordinate value of the target point; and
determining the rendering parameter based on the volume density and the color parameter.

15. The electronic device according to claim 12, wherein the determining a rendering parameter for the target point comprises:
determining the rendering parameter using a first fully connected neural network model.

16. The electronic device according to claim 15, further comprising:
determining a volume corresponding to the target scenario; and
dividing the volume into a plurality of sub-volumes, wherein the sub-volumes in the plurality of sub-volumes comprise the target point.

17. The electronic device according to claim 16, wherein the actions further comprise:
performing parallel processing on points in the plurality of sub-volumes using a plurality of fully connected neural network models, the plurality of fully connected neural network models comprising the first fully connected neural network model.

18. The electronic device according to claim 12, wherein the adjusting the rendering parameter comprises:
generating a two-dimensional data representation for the rendering parameter and the viewing direction based on the rendering parameter and the viewing direction; and
adjusting the rendering parameter based on the two-dimensional data representation and by upsampling the two-dimensional data representation.

19. The electronic device according to claim 18, wherein the generating a two-dimensional data representation for the rendering parameter and the viewing direction comprises:
rearranging the value of each parameter in the rendering parameter to generate the corresponding two-dimensional data representation; and
determining the two-dimensional data representation for the viewing direction based on the viewing direction and a predetermined matrix.

20. A computer program product that is tangibly stored on a non-transitory computer-readable medium and comprises machine-executable instructions, wherein the machine-executable instructions, when executed by a machine, cause the machine to perform a method, the method comprising:
determining, based on a coordinate value of a target point in a target scenario and a viewing direction for the target point, a rendering parameter for the target point;
adjusting the rendering parameter based on the viewing direction and by performing an upsampling operation on the rendering parameter; and
rendering an image for the target scenario based on the adjusted rendering parameter.
